(19) United States
(12) Patent Application Publication
(10) Pub. No.: US 2008/0178550 A1
(43) Pub. Date: Jul. 31, 2008

(54) BUILDING PANEL

(76) Inventors: Timothy M. Pierzynski, Apple Creek, OH (US); Erik Skov, Akron, OH (US)

Correspondence Address: Dennis J. Williamson;Moore & Van Allen, PLLC, P.O. Box 13706, Research Triangle Park, NC, 27709, US

(21) Appl. No.: 11/668,134

(22) Filed: Jan. 29, 2007

(51) Int. Cl. E04D 1/00; B28B 11/08

(52) U.S. Cl. 52/554; 264/293

(57) ABSTRACT

A plastic material panel includes a primary three-dimensional pattern formed on a surface thereof. In one embodiment the primary three-dimensional pattern defines a plurality of simulated roofing shingles, shakes or tiles. A plurality of different secondary three-dimensional patterns are also formed over the surface of the panel. The secondary three-dimensional patterns are arranged such that different ones of the second three-dimensional patterns are used on different areas of the first three-dimensional pattern.

The invention relates generally to resin building panels and, more particularly, to an improved surface configuration for such panels.

### BACKGROUND OF THE INVENTION

Resin buildings such as sheds, storage buildings and the like are known. Such buildings typically comprise a plurality of plastic panels that are connected together to create a finished building. The buildings may be all-plastic or may include a combination of plastic components and non-plastic components. The panels may be injection molded, blow molded or otherwise manufactured from a resin based material.

In order to create an appearance that simulates materials such as wood, shingles or the like it is known to mold three-dimensional patterns on the panels. Such patterns attempt to mimic the patterns found in the original material in order to create an optical impression to the eye similar to that of the original material. While the use of such surface patterns is known, the optics of such patterns has not been completely satisfactory.

Thus, an improved panel for use in storage buildings is desired.

### SUMMARY OF THE INVENTION

The panel of the invention comprises a plastic material panel made by any suitable manufacturing process such as blow molding, injection molding, insert molding or the like. The panel includes a primary three-dimensional pattern formed on a surface thereof. In one embodiment the primary three-dimensional pattern simulates roofing shingles, shakes or tiles as installed on a roof. A plurality of different secondary three-dimensional patterns are also formed over the surface of the panel. The secondary three-dimensional patterns simulate the texture of the roofing shingles or the like and each comprise variegated patterns of raised and recessed areas. The secondary three-dimensional patterns are arranged such that different ones of the secondary three-dimensional patterns are used on different portions of the primary three-dimensional pattern.

### BRIEF DESCRIPTION OF THE DRAWINGS

FIG. 1 is a plan view of one embodiment of a roofing panel of the invention.

FIG. 2 is a section view taken along line K-K of FIG. 1.

FIG. 3 is a section view taken along line A-A of FIG. 1.

FIG. 4 is a section view taken along line L-L of FIG. 1.

FIG. 5 is a partial plan view of one embodiment of the roofing panel of the invention showing embodiments of the plurality of secondary patterns in greater detail.

FIG. 6 is a flow chart illustrating a method of making the panel of the invention.

FIG. 7 is a top view of roof panels installed on a building.

FIG. 8 is a front view of roof panels installed on a building.

FIG. 9 is a side view of roof panels installed on a building.

FIG. 10 is a back view of roof panels as installed on a building.

### DETAILED DESCRIPTION OF EMBODIMENTS OF THE INVENTION

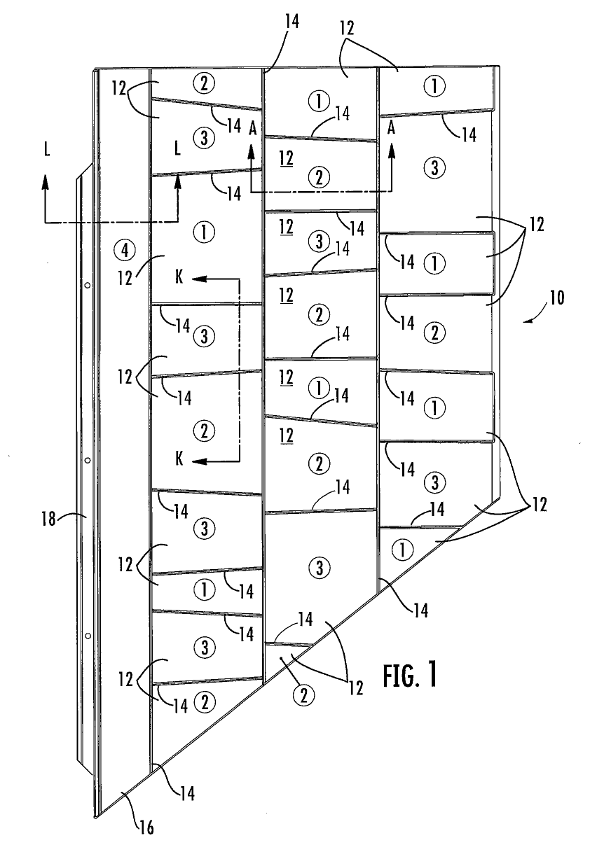

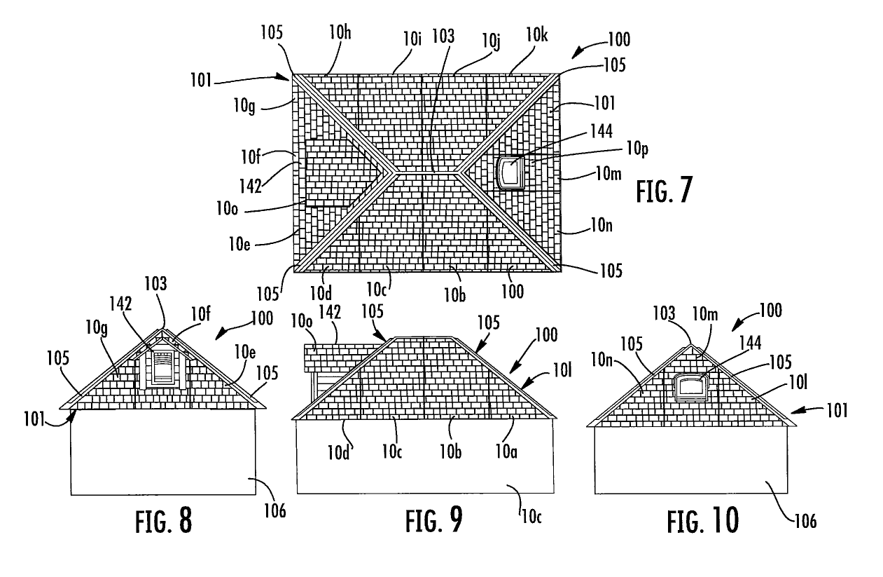

Referring to FIGS. 1 through 4, an embodiment of a roofing panel is shown generally at 10 made of any suitable plastic material such as vinyl, polyethylene, polyvinylchloride, polypropylene or the like. The roofing panel 10 may also be made of other moldable materials such as a composite mixture of plastic and cellulosic material. As used herein the term plastic material includes any material that that comprises a plastic or resin based material. Further, the panel may be made by any suitable molding process including injection molding, blow molding, insert molding, extrusion molding or other suitable embossing process. As used herein the term molding includes any process for forming a panel from the plastic material. The panel may also include non-plastic components such as reinforcement members, fasteners or the like that may be formed integrally with the panel or as separate components. Finally, the panel may be shaped and dimensioned to fit the particular building on which it is to be used and a single building may have panels that come in a variety of shapes and sizes and that are fit together in the finished structure as shown in FIGS. 7 through 10.

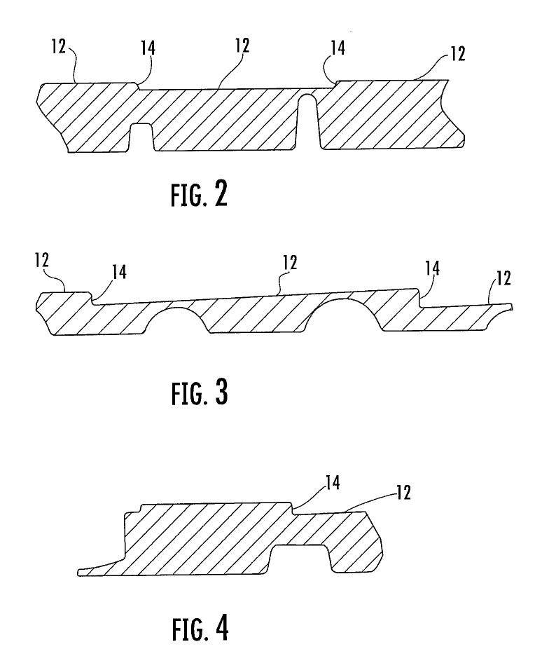

anel 10 is formed with a primary three-dimensional pattern that simulates a pattern of roofing tiles, shakes or shingles as installed on a roof. The primary pattern is created using a plurality of adjacent raised and recessed areas 12. In one embodiment the different areas have irregular polygonal shapes and are arranged in rows although different configurations of the areas 12 may be used. As best shown in FIGS. 2, 3 and 4 each area 12 is formed as a raised or recessed area relative to its adjacent areas such that each area is bounded by a border edge 14 where the border edge is disposed at an angle relative to the surface of the raised/recessed areas 12. As a result, different portions of the surface project from the surface of the panel different distances to create an embossed surface with the primary pattern projected in relief. The effect of such an arrangement creates the visual impression of a plurality of shingles, shakes or tiles on a roof.

A plurality of secondary three-dimensional patterns are also formed on the surface of the panel. In the illustrated embodiment four such secondary patterns are used. Each secondary pattern covers the surface of one or more of the raised or recessed areas 12 such that the different secondary patterns are disposed relatively randomly over the surface of the panel. In FIG. 1 the raised/recessed areas having the first secondary pattern are designated by reference numeral 1; the raised/recessed areas having the second secondary pattern are designated by reference numeral 2; the raised/recessed areas having the third secondary pattern are designated by reference numeral 3; and the raised/recessed areas having the fourth secondary pattern are designated by reference numeral 4. The first, second and third secondary patterns are arranged on the areas 12 such that the secondary patterns are interspersed in a random manner throughout the surface of the panel.

In the illustrated embodiment the fourth secondary pattern comprises a relatively flat surface and is used in those areas where surface texture is not wanted and/or needed. The fourth secondary pattern may be used in the border edge areas 14 to further in define the primary pattern and in those areas of the roof panel that will not be visible in the assembled building. For example, in the roof panel of FIG. 1 area 16 will underlay the adjacent panel such that it is not visible in the assembled building and area 18 comprises a mounting flange for receiving fasteners to secure the roof panel to the building.

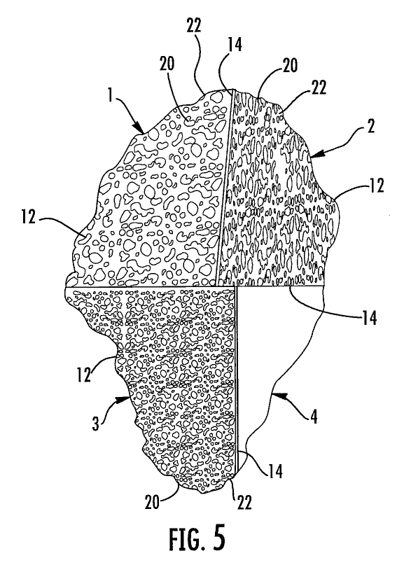

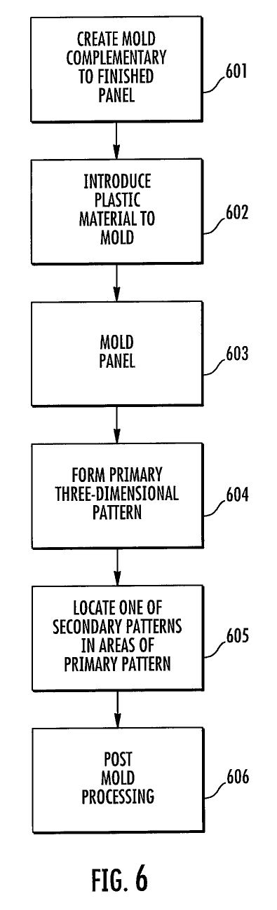

The first secondary pattern 1, second secondary pattern 2, and third secondary pattern 3 are illustrated in FIG. 5 and include small raised and/or recessed areas 20 interspersed about a relatively flat surface 22. The fourth secondary pattern 4 is also shown as a flat surface. The small raised areas 20 create a “pebbled” or “dimpled” surface where light reflects off of the roof panel in irregular patterns. In one embodiment the raised areas 20 may range from approximately 1/32 of an inch to ⅜ of an inch in length on a panel 10 that may be several feet in length. While each of the secondary patterns are similar in that the relative sizes of the raised areas 22 relative to the overall size of the panel are similar, the specific shapes, sizes, spacing and arrangements of the raised areas 20 are different between each of the secondary patterns. For example, the raised areas 20 in the first secondary pattern I are relatively larger and wider spaced than the raised areas 20 in the third secondary pattern 3 while the raised areas 20 in the second secondary pattern 2 are relatively longer than the raised areas 20 in either the first or third secondary pattern. While specific configurations of the secondary patterns are illustrated, the actual patterns may vary greatly from those shown in the drawings. While the first, second and third secondary patterns differ, the pattern of the raised portions within a secondary pattern may be repeated. In one embodiment the secondary patterns are selected such that the reflection of light is different from each of the secondary patterns while the appearance of the different secondary patterns is not readily apparent from a cursory view of the panel. The result is that the different secondary patterns reflect light slightly differently from one another and the optical effect is that to an observer's eye the overall appearance of the roof panel looks less like a molded plastic product and more like the tiles, shingles or shakes that the panel is simulating.

To manufacture the panel of the invention a mold is created that is complementary to the finished panel (block 601), i.e. the raised panel areas are recessed in the mold and the recessed panel areas are raised in the mold. The mold includes both the primary pattern and the secondary patterns as previously described. Plastic material is introduced into the mold such as by injection molding, blow molding, extrusion molding or other suitable process (block 602). The panel is molded from the plastic material (block 603). A primary pattern of a plurality of raised and recessed areas and a plurality of secondary patterns is formed on the panel (block 604). One of the plurality of secondary patterns is located in each of the plurality of raised and recessed areas (block 605). The formed panel is removed from the mold and may be subject to post molding processes including painting or the like (block 606).

Referring to FIGS. 7, 8, 9 and 10, a structure such as a storage building, shed or the like 100 may be assembled using the panels 10. The roof assembly is shown generally at 101 and comprises a plurality of roof panels 10a through 10n constructed as set forth above using the primary pattern and a plurality of secondary patterns as previously explained. While the panel of the invention has particular use in such sheds it will be appreciated that the panels have utility in any structure or building having an installed roof. The roof panels 10a-n are supported on walls 106 and may be supported and separated by a ridge cap 103 at the top of the roof and corner caps 105 at each of the hip joints. Features such as dormers 142 and 144 including roof panels 10o and 10p made as described herein may also be included. Details of the building such as doors and windows have been omitted. While a hip roof is illustrated it is to be understood that the panels may be used on roofs having different configurations.

Specific embodiments of an invention are described herein. One of ordinary skill in the art will recognize that the invention has other applications in other environments. In fact, many embodiments and implementations are possible. The following claims are in no way intended to limit the scope of the invention to the specific embodiments described above.

1. A plastic material panel comprising:
a primary pattern of a plurality of raised and recessed areas;
a plurality of secondary patterns, one of said plurality of secondary patterns located in each of said plurality of raised and recessed areas.

2. The panel of claim 1 wherein one of said plurality of secondary patterns substantially covers each of said plurality of raised and recessed areas.

3. The panel of claim 1 wherein said plurality of secondary patterns include raised portions.

4. The panel of claim 3 wherein the raised portions are different for each of said plurality of secondary patterns.

5. The panel of claim 3 wherein the raised portions are spaced differently for each of said plurality of secondary patterns.

6. The panel of claim 3 wherein the raised portions are sized differently for each of said plurality of secondary patterns.

7. The panel of claim 3 wherein the raised portions are spaced differently for each of said plurality of secondary patterns.

8. The panel of claim 1 wherein each of the plurality of secondary patterns reflect light differently.

9. The panel of claim 1 wherein the primary pattern is molded in the panel.

10. The panel of claim 1 wherein the plurality of secondary patterns are molded in the panel.

11. A roof panel comprising:
a roof panel molded from a plastic material;
a primary pattern of a plurality of raised and recessed areas simulating a roof construction;
a plurality of secondary patterns molded into said panel, one of said plurality of secondary patterns located in each of said plurality of raised and recessed areas wherein said plurality of secondary patterns include raised portions and wherein the raised portions are different for each of said plurality of secondary patterns.

12. The roof panel of claim 11 wherein the primary pattern simulates shingles, shakes or tiles.

13. The panel of claim 11 wherein the raised portions are spaced differently for each of said plurality of secondary patterns.

14. The panel of claim 11 wherein the raised portions are sized differently for each of said plurality of secondary patterns.

15. The panel of claim 1 1 wherein the raised portions are spaced differently for each of said plurality of secondary patterns.

16. The panel of claim 11 wherein each of the plurality of secondary patterns reflect light differently.

17. A method of making a roof panel comprising:
molding a panel from plastic material;
forming a primary pattern of a plurality of raised and recessed areas and a plurality of secondary patterns, and
locating one of said plurality of secondary patterns in each of said plurality of raised and recessed areas.

18. A building comprising:
a plurality of walls; and
a roof supported on said walls, said roof comprising:
at least one roof panel formed of a plastic material, said at least one roof panel having a primary three-dimensional pattern of a plurality of areas and a plurality of secondary patterns, one of said plurality of secondary patterns located in each of said plurality of areas.
